(19) United States
(12) Patent Application Publication
(10) Pub. No.: US 2025/0180169 A1
(43) Pub. Date: Jun. 5, 2025

(54) FLUID FLOW DIVERSION FITTING FOR USE WITH AQUEOUS FLUID TANKS

(71) Applicant: Flexcon Industries, Inc., RANDOLPH, MA (US)

(72) Inventor: Matthew Daniel Kearney, Hanson, MA (US)

(73) Assignee: Flexcon Industries, Inc., RANDOLPH, MA (US)

(21) Appl. No.: 18/963,021

(22) Filed: Nov. 27, 2024

Related U.S. Application Data
(60) Provisional application No. 63/604,939, filed on Dec. 1, 2023.

(51) Int. Cl. F17C 13/04

(52) U.S. Cl. CPC F17C 13/04; F17C 2205/0302

(57) ABSTRACT

A diversion fitting for a continuous flow liquid supply system. The diversion fitting includes a flow-through conduit including a first arm and a second arm. The flow-through conduit forms a flow-through channel between the first arm and the second arm along a centerline. The diversion fitting includes a leg extending perpendicular to the centerline and forms an inlet flow channel. The diversion fitting includes a diversion ramp disposed in the flow-through conduit aligned with the inlet flow channel. The diversion ramp is disposed at an angle with respect to the centerline such that the ramp faces toward the first arm and the leg. The diversion ramp is disposed within the flow-through channel between such that a first portion of a fluid flow entering the first arm is diverted into the inlet flow channel and a second portion of the fluid flow continues to the second arm.

### CROSS-REFERENCE TO RELATED APPLICATIONS

This application claims priority to U.S. Provisional Application No. 63/604,939, filed Dec. 1, 2023, the entirety of which is incorporated by reference herein.

### TECHNICAL FIELD

In some embodiments, the disclosure relates to improved fluid connector assemblies. More specifically, in some embodiments, the disclosure relates to fluid connector assemblies that may provide continuous flowing water between a flow-through conduit and a storage tank or an expansion tank.

### BACKGROUND

The background description provided herein is for the purpose of generally presenting the context of the disclosure. The work of the presently named inventors, to the extent it is described in this background section, as well as aspects of the description that may not otherwise qualify as prior art at the time of filing, are neither expressly nor impliedly admitted as prior art against the present disclosure.

Expansion tanks are a type of storage tanks traditionally used in flow systems for controlling flow of liquid under varying pressures. Generally, expansion tanks may comprise substantially cylindrical or spherical housing that may include a bladder-type diaphragm dividing regions that may hold a first fluid (e.g., water or other liquid or gas) and a second pressurized fluid (e.g., gas).

An expansion tank generally includes one flow connection through which fluid may flow in and out depending on the pressure level controlled by the contraction and expansion of an interior diaphragm. It may be advantageous to substantially constantly or frequently circulate the fluid (e.g., water, particularly potable water) through the expansion tank when the flow-through conduit contains a liquid flow, so as to help prevent or reduce the accumulation of any stagnant water in the tank.

### SUMMARY

The following presents a simplified summary of the present disclosure in order to provide a basic understanding of some aspects of the disclosure. This summary is not an extensive overview of the disclosure. It is not intended to identify key or critical elements of the disclosure or to delineate the scope of the disclosure. The following summary merely presents some concepts of the disclosure in a simplified form as a prelude to the more detailed description provided below.

In some embodiments, the disclosure describes a diversion fitting for diverting fluid into a storage tank. The diversion fitting may include a flow-through conduit including a first arm and a second arm opposite one another. The flow-through conduit may form a flow-through channel between the first arm and the second arm along a flow-through centerline. The diversion fitting may include a leg extending from the flow-through conduit substantially perpendicular to the flow-through centerline. The leg may form an inlet flow channel in fluid communication with the flow-through channel. The diversion fitting may include a diversion ramp integrally formed with the flow-through conduit and substantially aligned with the leg along the flow-through channel. The diversion ramp may have a ramp surface disposed at an angle between about 30 degrees and about 60 degrees with respect to the flow-through centerline. The diversion ramp may be disposed within the flow-through channel between the first arm and the second arm such that the ramp surface may be facing substantially toward the first arm and the leg so as to divert a first portion of a fluid flow entering the first arm into the inlet flow channel and a second portion of the fluid flow continues to the second arm.

In another embodiment, the disclosure describes a diversion fitting for a continuous flow liquid supply system. The diversion fitting may include a flow-through conduit including a first arm and a second arm opposite one another. The flow-through conduit may form a flow-through channel between the first arm and the second arm along a flow-through centerline. The diversion fitting may include a leg extending substantially perpendicular to the flow-through centerline. The leg may form an inlet flow channel in fluid communication with the flow-through channel. The diversion fitting may include a diversion ramp disposed on an inner surface of the flow-through conduit substantially aligned with the inlet flow channel. The diversion ramp may have a ramp surface disposed at an angle A with respect to the flow-through centerline such that the ramp surface is facing toward the first arm and the leg. The diversion ramp may be disposed within the flow-through channel between the first arm and the second arm such that a first portion of a fluid flow entering the first arm may be diverted into the inlet flow channel and a second portion of the fluid flow continues to the second arm.

In another embodiment, the disclosure describes a system for continuous flow supply. The system may include a storage tank and a flow connection providing fluid communication between an interior and an exterior of the storage tank. The system may include a diversion fitting including a leg connected to the flow connection on the exterior of the storage tank so as to provide fluid communication between the diversion fitting and the interior of the storage tank. The diversion fitting may include a flow-through conduit including a first arm and a second arm opposite one another. The flow-through conduit may form a flow-through channel between the first arm and the second arm along a flow-through centerline that is substantially perpendicular to the leg. The diversion fitting may include a diversion ramp disposed substantially aligned with the leg, the diversion ramp having a ramp surface disposed at an angle A with respect to the flow-through centerline such that the ramp surface is facing toward the first arm and the leg. The diversion ramp may be disposed such that a first portion of a fluid flow entering the first arm may be diverted into the interior of the storage tank through the flow connection and a second portion of the fluid flow continues to the second arm.

### BRIEF DESCRIPTION OF THE DRAWINGS

The invention may be better understood by references to the detailed description when considered in connection with the accompanying drawings. The components in the figures are not necessarily to scale, emphasis instead being placed upon illustrating the principles of the invention. In the figures, like reference numerals designate corresponding parts throughout the different views.

FIG. 1 is a perspective sectional view of an embodiment of a diversion fitting in accordance with disclosure;

FIG. 2 is a left side elevational view of the diversion fitting of FIG. 1;

FIG. 3 is a top view of the diversion fitting of FIG. 1;

FIG. 4 is a right side elevational view of the diversion fitting of FIG. 1;

FIG. 5A is an embodiment of a tank system including the diversion fitting of FIG. 1; and

FIG. 5B is a detailed sectional view of a portion of the tank system of FIG. 5A.

### DETAILED DESCRIPTION

The present invention now will be described more fully hereinafter with reference to the accompanying drawings, which form a part hereof, and which show, by way of illustration, specific exemplary embodiments by which the invention may be practiced. These illustrations and exemplary embodiments are presented with the understanding that the present disclosure is an exemplification of the principles of one or more inventions and is not intended to limit any one of the inventions to the embodiments illustrated. The invention may be embodied in many different forms and should not be construed as limited to the embodiments set forth herein; rather, these embodiments are provided so that this disclosure will be thorough and complete, and will fully convey the scope of the invention to those skilled in the art. Among other things, the present invention may be embodied as methods or devices. The following detailed description is, therefore, not to be taken in a limiting sense.

The figures depict embodiments for purposes of illustration only. One skilled in the art will readily recognize from the following discussion that alternative embodiments of the structures and methods illustrated herein may be employed without departing from the principles described herein.

The disclosure describes, in some embodiments, diversion fittings in a flow-through conduit of expansion tanks or storage thanks. In some embodiments, the diversion fittings may be used to direct some portion of a flow volume in a pipe section into a storage vessel to exchange water within that storage vessel. The geometry used to create the flow diversion within the piping may be completely contained within the structure of the metal “tee” fitting (i.e., diversion fitting) and may utilizes no mechanical components. One advantage to such a construction may be that the reduction of mechanical components may allow for improved production speed with reduced risk of quality concerns. In some embodiments implementing the diversion fittings described in this disclosure, a water exchange rate in and out of the storage tank may be improved by at least about 10 percent compared to traditional methods. In some embodiments, the diversion fittings may direct a portion of a flow volume in a flow-through member or conduit into the storage vessel and/or expansions tanks to exchange fluid (e.g., water) within that storage vessel. In some embodiments, this fluid exchange may occur whether or not there may be net fluid flow out of the tank. The exchange of water within the tank or vessel may help prevent stagnant water within the vessel, as water may be constantly or at least frequently flushed into and out of the vessel, which may limit the growth of undesirable microorganisms in the tank.

Some non-limiting examples of tank types in which such diversion fittings may be useful may include:

Pre-pressurized tanks with a double diaphragm used with VFD (variable frequency drive) pumps;

Pre-pressurized tanks with a double diaphragm used with standard control (i.e., pressure switch) pumps;

Open tanks used in air-over-water pressurization water systems; and/or

Open tanks used in off gassing applications.

Other types of tanks, vessels, or other suitable environments will be evident to those skilled in the art and within the scope of this disclosure. Non-limiting examples of the disclosed system are shown and described with reference to the attached drawings.

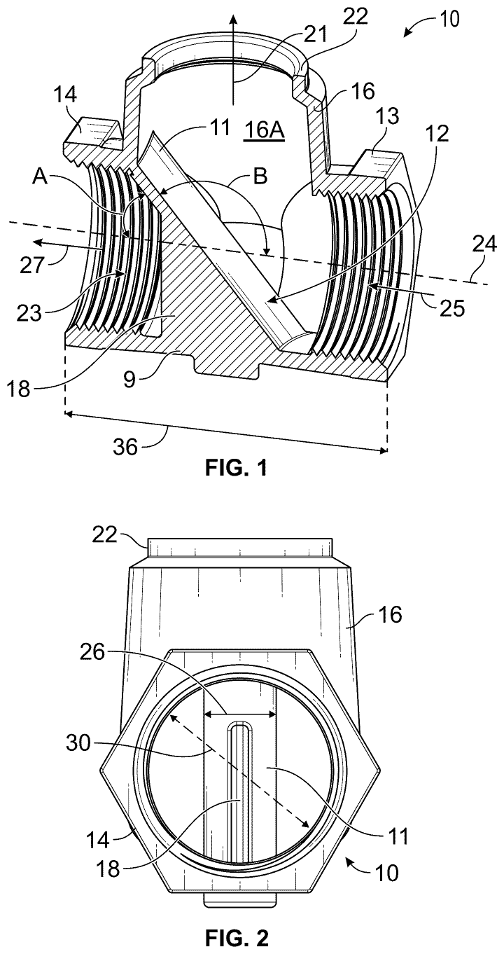

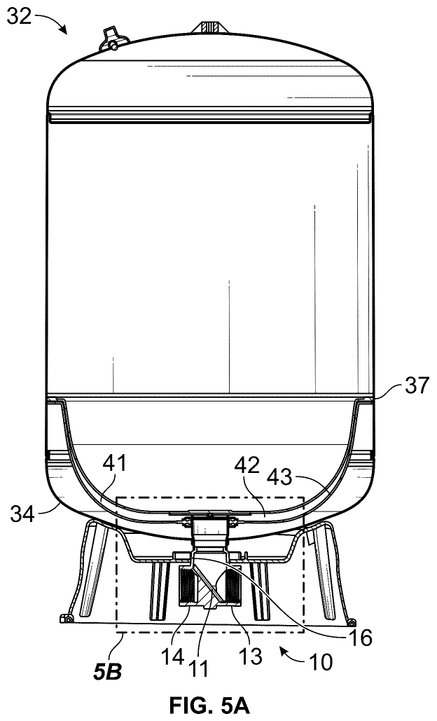

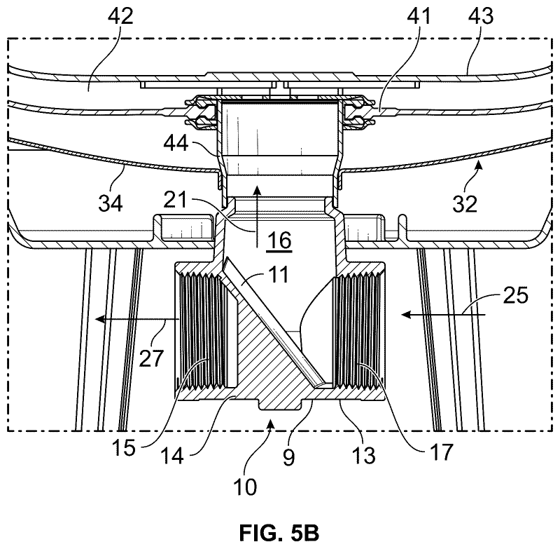

Referring to FIG. 5A, a pre-pressurized tank 32 (which may be a double diaphragm tank) may be in sealed fluid flow connection with a flow-through pipe through an interconnected diversion fitting, e.g., tee fitting 10. Details of an embodiment of the tee fitting 10 are shown and descried with reference to FIGS. 1-4. In some embodiments, the tank 32 may include an outer shell 34, an outer diaphragm 41 that may be rigid, and an inner diaphragm 43. A liquid-tight volume 42 may be formed between the outer and inner diaphragms 41, 43. In some embodiments, the inner diaphragm 41 and the outer diaphragm may be sealed to one another to form a circumferential seam 37 and the volume 42 may be fluidically isolated from the outer shell 34 FIG. 5B shows a partial magnified view of an embodiment of a lower portion of the tank 32 and the tank's support structure. The tee fitting 10 may be connected to the tank 32. FIG. 5B also shows an embodiment of connections with the tank 32, including a flow connection 44 through the outer diaphragm 41 of the tank 32 into the liquid-tight volume 42 formed between the outer and inner diaphragms 41, 43. In some embodiments, the flow connection 44 may provide fluid communication from the liquid-tight volume 42, through the outer diaphragm 41, to an exterior of the outer shell 34. In some embodiments, the tee fitting 10 may sealingly connect to the flow connection 44 to provide fluid into and/or out of the liquid-tight volume 42 from the tee fitting 10.

In some embodiments, the tee fitting 10 may include structure configured to divert water into the storage tank 32. The tee fitting 10 may be formed of metal but in certain circumstances may be formed of a strong rigid plastic or other strong, rigid material. The tee fitting 10 may include a flow-through conduit 9 (i.e., flow-through cross-piece) with a first arm 13 forming a first flow channel 25 and a second arm 14 opposite the first arm and forming a second flow channel 27. In some embodiments, the first and second flow channels 25, 27 may form a flow-through channel between the first arm 13 and the second arm 14. The tee fitting 10 may also include a leg 16 that may extend from the flow-through conduit 9 in a direction substantially perpendicular to the flow-through conduit and the flow-through channel. The leg 16 may form an inlet flow channel 21 that may be in fluid communication with the flow-through channel within the flow-through conduit 9. The inlet flow channel 21 may be within the leg such that fluid flowing through the inlet flow channel (e.g., into the tank 32) may flow in a direction substantially perpendicular and/or transverse to fluid flowing through the flow-through channel. In some embodiments, the tee fitting 10 may be connected into one or more flow pipes at a position that may be substantially transverse to the inlet flow channel 21 into the tank 32 through the leg 16. In some embodiments, a collar 22 may surround an outlet from the leg 16 into the tank 32 and may make up a portion of the inlet flow channel 21. In some embodiments, the collar 22 may provide a substantially fluid-tight connection between the tee fitting 10 and the tank 32. The first and second flow channels 25, 27 of the first and second arms 13, 14 of the tee fitting 10, respectively, may form a portion of a length of the through-flow pipe and may be connected, for example, by threaded internal connections 15, 17, respectively. In some embodiments, the first and second flow channels 25, 27 of first and second arms 13, 14, respectively, may be substantially identically sized as one another. In some embodiments, the inlet flow channel 21 of the leg 16 may be the same size or smaller in diameter compared to the first and second flow channels 25, 27 of the first and second arms 13, 14.

The tee fitting 10 may include geometry, such as threaded internal connections 15, 17 at opposed ends of the first and second arms 13, 14 of the tee 10, that may be configured for attaching into other piping. In some embodiments, the tee fitting 10 may provide fluid communication between a flow-through pipe system, such as a pipe bringing potable water from a well or other source, and the tank 32.

FIG. 1 shows a cross-sectional view of an embodiment of the tee fitting 10. In some embodiments, the tee fitting 10 may include a diversion ramp 11 within the flow-through conduit 9 so as to interrupt fluid flow in the flow-through channel. In some embodiments, the diversion ramp 11 may include a ramp surface 12 that may face substantially toward the first arm 13 and may extend at an angle “A” to a centerline 24 of the first and second arms 13, 14. In some embodiments, the angle A may be between about 30 and about 60 degrees, or between about 40 and about 50 degrees in other embodiments, from the centerline 24. Supplemental angle “B” may be between about 150 and about 120 degrees from the centerline 24. In some embodiments, angle B may be between about 140 and about 130 degrees from the centerline 24. In some embodiments, the angle A may be about 42 degrees from the flow-through centerline 24, and the angle B may be about 138 degrees from the centerline. In some embodiments, the angle A may be about 52 degrees from the flow-through centerline 24, and the angle B may be about 128 degrees from the centerline. In some embodiments, the diversion ramp 11 may include a backside 23 that may include a rib 18 that may connect the diversion ramp 11 to the tee fitting 10.

In some embodiments, the diversion ramp 11 may include a substantially cupped or U-shaped concave profile that may direct and hold water flowing from the first flow channel 25, up the ramp surface 12, into the inlet flow channel 21 in the leg 16, which may provide a fluid flow connection with into the tank 32. In some embodiments, the curved cup, concave profile of the diversion ramp 11 may form a cross section of the ramp that may be an arc of a circle. In some embodiments, the diversion ramp may be a flat ramp with substantially straight sides extending from a flat bottom surface towards the leg 16 and the tank 32. In some embodiments, the diversion ramp 11 may include a substantially smooth transition between an inner portion of the flow-through conduit 9 and the ramp surface 12.

In some embodiments, the diversion ramp 11 may extend diagonally across a central volume 16A of the tee fitting 10, beneath and substantially aligned with the leg 16 along the flow-through centerline 24 between the first and second arms 13, 14, with a ramp surface 12 facing substantially towards the tank 32, to divert flow into the tank 32. In some embodiments, the ramp surface 12 may be facing substantially toward both the leg 16 and the first arm 13.

In some embodiments, the diversion ramp 11 may be configured in size and positioned within the tee fitting 10 such that a first portion of the fluid flow in that may enter the tee fitting via the first flow channel 25 may diverted into the inlet channel 21 and into the tank 32, while a second portion of the fluid flow that may enter the tee fitting via the first flow channel 25 may flow past the diversion ramp 11 and into the second flow channel 27. In some embodiments, the diversion ramp 11 may be limited in size to reduce flow losses (head loss) in the flow-through system. In some embodiments, a width 26 of the diversion ramp 11 that may be substantially directly facing the first flow channel 25 from the first arm 13 may be configured to be large enough to divert sufficient flow into the tank 32, but not too large such that the ramp may cause undue high head loss in the through-pipe.

In some embodiments, the width 26 of the diversion ramp 11 may be about ⅝ inch in a 1¼″ NPT tee. In some embodiments, a ratio between the width 26 of the diversion ramp 11 and an inner diameter 28 of the first arm 13 may be between about 0.3 and about 0.5. In some embodiments, this ratio may be between about 0.35 and about 0.45. In some embodiments, this ratio may be about 0.40 in other embodiments. In some embodiments, a ratio between the width 26 of the diversion ramp 11 and an inner diameter 33 of the leg 16 may be between about 0.3 and about 0.6. In some embodiments, this ratio may be between about 0.4 and about 0.5. In some embodiments, this ratio may be about 0.47. In some embodiments, a ratio between the width 26 of the diversion ramp 11 and the nominal pipe size of the tee fitting 10 may be about 0.5. In some embodiments, this ratio may be between about 0.45 and about 0.55. In some embodiments, this ratio may be between about 0.4 and about 0.6. In some embodiments, this ratio may be between about 0.35 and about 0.65. In some embodiments, the width 26 of the diversion ramp 11 may be about 0.6 inches, the inner diameter 28 of the first arm 13 may be about 1.5 inches, and the inner diameter 30 of the second arm 14 may be about 1.5 inches, and the inner diameter of the leg 16 may be about 1.3 inches. In some embodiments, the inner diameter 28 of the first leg 13 may be substantially equal to the inner diameter 30 of the second leg 14. In some embodiments, an overall length 36 of the flow-through conduit 9 may be relatively small compared to the piping sections to which it may be connected. For example, in some embodiments, the overall length 36 of the flow-through conduit 9 may be between about 2 inches and about 6 inches, or between about 4 inches and 6 inches in other embodiments, or may be about 3 inches in some embodiments.

In some embodiments, the diversion ramp 11 may be sized, positioned, and/or configured so as to reduce flow-through the through the first and second arms 13, 14 by less than or equal to 40 percent. In other words, in some embodiments, the diversion ramp 11 may be configured such that a fluid flow exiting the tee fitting 10 through the second flow channel 27 may be greater than or equal to 60 percent of a fluid flow entering the tee fitting through the first flow channel 25. Those skilled in the art will recognize that the diversion ramp 11 may be configured such that different proportions of fluid flow may be diverted into the tank 32 within the scope of the disclosure. In some embodiments, fluid circulating within the tank 32 may exit the tank through the tee fitting 10 and flow through the second arm 14 back into the piping system.

Referring to FIG. 2, in some embodiments, the diversion ramp 11 may include a rib 18 on a backside 23 opposite the cupped flow surface. The rib 18 may be rigidly connected to an inner surface of the tee fitting 10, such as for structural purposes and/or flow alignment. In some embodiments, the rib 18 and the ramp 11 may be molded integrally with and/or as part of the tee fitting 10, as shown in FIGS. 1 and 2.

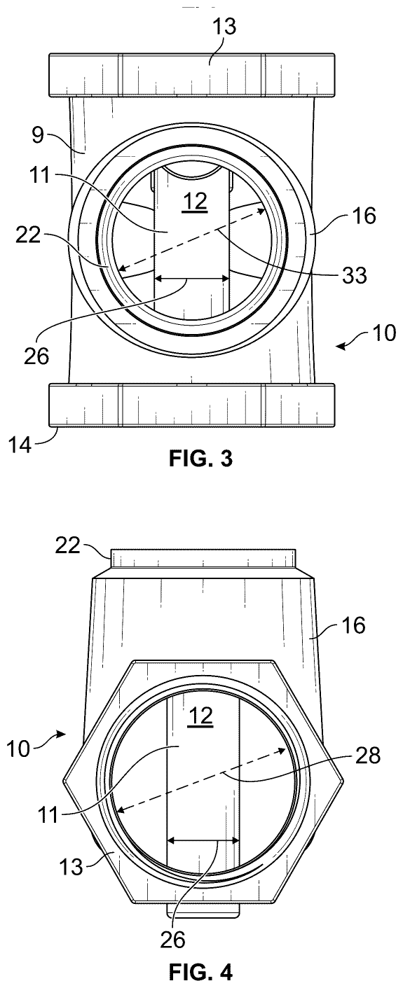

FIG. 3 is a top view of the tee fitting 10, showing a view down into the interior volume of the tee fitting through the collar 22 and leg 16. FIG. 4 is a side view of the tee fitting 10, showing a view into the interior volume of the tee fitting 10 through the first arm 13. Both views show the ramp surface 12 of the diversion ramp 11. In the illustrated embodiment, the ramp 11 is shown as disposed substantially in the center of the flow path through the first flow channel 25 toward the second flow channel 27. However, those skilled in the art will appreciate that, in some embodiments, the diversion ramp 11 may be disposed on either side of the flow path, such as adjacent one or both side walls of the tee fitting 10. In some embodiments, the diversion ramp 11 may be split into two or more portions, with a first portion on a first side and a second portion on a second side of the tee fitting 10 interior, or a first portion of the diversion ramp in the center and a second (or third) portion of the ramp on one or both sides.

Some advantages of the disclosed design for the tee fitting 10 and the diversion ramp 11 may be that it is relatively simple in its geometry, which may reduce manufacturing costs. In some embodiments, the complete tee fitting 10 may be manufactured as a single molded unit. In some embodiments, the tee fitting 10 may be manufactured in multiple parts (e.g., two parts) and then welded or otherwise connected together into a single, fluid-tight unit. Another advantage of the disclosed tee fitting 10 is that it may be more relatively easily connected to the related tank (e.g., tank 32) and into the flow-through system.

FIGS. 5A and 5B depict one example of the connection into the tank volume that may allow for fluid flow into the volume 42 between the inner diaphragm 41 and the outer diaphragm 43. In some embodiments, such flow into the tank 32 may be sufficient to cause flow within and around the entire surface of the fluid-containing volume 42 of the tank between the two diaphragms. Substantially consistent and/or frequent fluid flow may help prevent or reduce the growth of dangerous bacteria within the liquid containing volume 42 of the tank without the necessity of completely emptying the tank for cleaning at short intervals.

In one embodiment in which the through flow pipes and/or the first arm 13, the second 14, and/or the leg 16 may each have an internal diameter of between about 1 inch to about 2 inches, (e.g., about 1.1 inches) and a fluid flow of between about 10 GPM and about 25 GPM, (e.g., about 12 GPM) through the first arm 13 (i.e., inlet). In some such embodiments, the flow along the ramp 11 upwardly into the tank 32, through the leg 16, which may be disposed above the through flow pipes and/or the first arm 13 and the second arm 14, may be sufficient to cause a desired flow around the inner surface of the double diaphragm tank 32.

Although the figures and description depict a double-diaphragm tank located above the tee fitting 10 and through flow pipe, those skilled in art will appreciate that the ramp 11 design may also be useful for situations where other types of storage tanks may be provided, and where any type of tank is provided below the tee fitting, or in any other orientation.

Upon reading this disclosure, those of skill in the art will appreciate still additional alternative structural and functional designs for the systems and methods described herein through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the systems and methods disclosed herein without departing from the spirit and scope defined in any appended claims.

1. A diversion fitting for diverting fluid into a storage tank, the diversion fitting comprising:
a flow-through conduit including a first arm and a second arm opposite one another, the flow-through conduit forming a flow-through channel between the first arm and the second arm along a flow-through centerline;
a leg extending from the flow-through conduit substantially perpendicular to the flow-through centerline, the leg forming an inlet flow channel in fluid communication with the flow-through channel; and
a diversion ramp integrally formed with the flow-through conduit and substantially aligned with the leg along the flow-through channel, the diversion ramp having a ramp surface disposed at an angle between about 30 degrees and about 60 degrees with respect to the flow-through centerline;
wherein the diversion ramp is disposed within the flow-through channel between the first arm and the second arm such that the ramp surface is facing substantially toward the first arm and the leg so as to divert a first portion of a fluid flow entering the first arm into the inlet flow channel and a second portion of the fluid flow continues to the second arm.

2. The diversion fitting of claim 1, wherein the diversion ramp has a width measured in a direction substantially perpendicular to the flow-through centerline, and wherein a ratio of the width to an inner diameter of the first leg is between about 0.3 and about 0.5.

3. The diversion fitting of claim 1, wherein the ramp surface is disposed at an angle between about 40 degrees and about 50 degrees.

4. The diversion fitting of claim 1, wherein the ramp surface has a concave profile.

5. A diversion fitting for a continuous flow liquid supply system, the diversion fitting comprising:
a flow-through conduit including a first arm and a second arm opposite one another, the flow-through conduit forming a flow-through channel between the first arm and the second arm along a flow-through centerline;
a leg extending substantially perpendicular to the flow-through centerline, the leg forming an inlet flow channel in fluid communication with the flow-through channel; and
a diversion ramp disposed on an inner surface of the flow-through conduit substantially aligned with the inlet flow channel, the diversion ramp having a ramp surface disposed at an angle A with respect to the flow-through centerline such that the ramp surface is facing toward the first arm and the leg,
wherein the diversion ramp is disposed within the flow-through channel between the first arm and the second arm such that a first portion of a fluid flow entering the first arm is diverted into the inlet flow channel and a second portion of the fluid flow continues to the second arm.

6. The diversion fitting of claim 5, wherein the ramp surface has a concave profile.

7. The diversion fitting of claim 5, wherein the angle A is between about 30 degrees and about 60 degrees.

8. The diversion fitting of claim 5, wherein the angle A is between about 40 degrees and about 50 degrees.

9. The diversion fitting of claim 5, wherein the angle A is about 42 degrees.

10. The diversion fitting of claim 5, wherein the first portion of the fluid flow diverted by the diversion ramp is less than or equal to about 40 percent of the fluid flow entering the diversion fitting through the first arm.

11. The diversion fitting of claim 5 further comprising a rib connecting the inner wall of the flow-through conduit to the diversion ramp such that the flow-through conduit, the rib, and the diversion ramp are integral with one another.

12. The diversion fitting of claim 5, wherein the diversion ramp has a width measured in a direction substantially perpendicular to the flow-through centerline, and wherein a ratio of width to an inner diameter of the first leg is between about 0.3 and about 0.5.

13. The diversion fitting of claim 5, wherein the diversion ramp has a width measured in a direction substantially perpendicular to the flow-through centerline, and wherein a ratio of the width to an inner diameter of the first leg is between about 0.4.

14. A system for continuous flow supply, the system comprising:
a storage tank;
a flow connection providing fluid communication between an interior and an exterior of the storage tank; and
a diversion fitting including a leg connected to the flow connection on the exterior of the storage tank so as to provide fluid communication between the diversion fitting and the interior of the storage tank, the diversion fitting including:
a flow-through conduit including a first arm and a second arm opposite one another, the flow-through conduit forming a flow-through channel between the first arm and the second arm along a flow-through centerline that is substantially perpendicular to the leg, and
a diversion ramp disposed substantially aligned with the leg, the diversion ramp having a ramp surface disposed at an angle A with respect to the flow-through centerline such that the ramp surface is facing toward the first arm and the leg;
wherein the diversion ramp is disposed such that a first portion of a fluid flow entering the first arm is diverted into the interior of the storage tank through the flow connection and a second portion of the fluid flow continues to the second arm.

15. The system of claim 14, wherein the storage tank further comprises an outer shell with an inner diaphragm and an outer diaphragm disposed within the outer shell, and wherein a substantially liquid-tight volume is formed between the inner diaphragm and the outer diaphragm and the leg provides fluid communication between the diversion fitting and the liquid-tight volume.

16. The system of claim 15, wherein the inner diaphragm is a flexible diaphragm and the outer diaphragm is a rigid diaphragm.

17. The system of claim 14, wherein the ramp surface has a concave profile.

18. The system of claim 14, wherein the angle A is between about 30 degrees and about 60 degrees.

19. The system of claim 14, wherein the angle A is between about 40 degrees and about 50 degrees.

20. The system of claim 14, wherein the first portion of the fluid flow diverted by the diversion ramp is less than or equal to about 40 percent of the fluid flow entering the diversion fitting through the first arm.
